(19) United States
(12) Patent Application Publication
(10) Pub. No.: US 2018/0273350 A1
(43) Pub. Date: Sep. 27, 2018

(54) CRANE

(71) Applicant: EPSILON Kran GmbH., Salzburg (AT)

(72) Inventors: Johannes STEINDL, Elsbethen (AT); Martin GALLER, Adnet (AT)

(21) Appl. No.: 15/928,883

(22) Filed: Mar. 22, 2018

(30) Foreign Application Priority Data
Mar. 23, 2017 (EP) 17162557.7

(51) Int. Cl. B66C 13/48; B66C 23/16; B66C 1/42

(52) U.S. Cl. CPC B66C 13/48; B66C 23/42; B66C 1/42; B66C 23/16

(57) ABSTRACT

A crane including a crane arm with a crane tip and an implement arrangeable on the crane tip. The at least one part of the implement is movable in relation to the crane tip. A crane controller controls the crane arm and the at least one part of the implement. The crane controller can issue control commands by a user for movement of the crane arm and for movement of the at least one part of the implement. With an implement on the crane tip, when predetermined control commands are issued by a user for movement of the at least one part of the implement arranged on the crane tip, additional control commands for movement of the at least one crane arm can be given off by the crane controller to at least partially compensate for the movement of the at least one part of the implement.

The invention relates to a crane with the features of the preamble of claim 1.

In a generic crane the crane arm, as well as an implement arranged on the crane tip or a part of an implement arranged on the crane tip, can be moved in relation to the crane arm by the issue of corresponding control commands by a user by means of the crane controller. A coordination of certain movements of the crane arm and certain movements of the implement or parts of the implement can place high demands on the user of the crane and be associated with increased operating costs and a slower working speed. Incorrect operation, for example by an insufficiently trained user or inattention, during a coordination of certain movements of the crane arm and certain movements of the implement or parts of the implement—but also in the case of inappropriate movement of the implement or parts of the implement—can also give rise to damage to the crane, to the implement, to any load to be lifted or to the base which serves as supporting surface for the crane or as depositing surface for any load to be lifted.

The object of the invention is to specify a crane which has an easier operability as well as increased safety with respect to incorrect operation.

This object is achieved by a crane with the features of claim 1. Advantageous embodiments of the invention are defined in the dependent claims.

As with a generic crane, the crane according to the invention also has firstly at least one crane arm with a crane tip, wherein an implement is arrangeable on the crane tip. For example, a free end of the crane arm can be understood as the crane tip. The implement itself and/or at least one part of the implement is movable in relation to the crane tip. In principle an attachment part arrangeable on the crane tip for manipulation of objects or items, for example a load to be lifted, can be understood as the implement. The at least one crane arm and the implement and/or the at least one part of the implement can be controlled by a crane controller, wherein in a first operating mode the crane controller is formed for the issue of control commands by a user for movement of the at least one crane arm and for movement of the implement and/or for movement of the at least one part of the implement. In other words, in the first operating mode of the crane controller, by means of the latter, a user can issue control commands to the crane arm and the implement (or the at least one movable part of the implement). The crane arm and the implement (or the at least one movable part of the implement) can be controlled separately from each other or also together by the issue of corresponding control commands by the user. The crane arm of the crane or the crane tip of the crane arm can be substantially freely movable in the first operating mode of the crane controller—within the possible, structurally limited range of movement and optionally taking into account the stability of the crane.

In contrast to cranes known in the state of the art, the crane controller of the crane according to the invention has an activatable further operating mode, in which the crane controller is configured so that, with an implement arranged on the crane tip, when predetermined control commands are issued by a user for movement of the implement arranged on the crane tip and/or for movement of the at least one part of the implement arranged on the crane tip, additional control commands for movement of the at least one crane arm can be given off by the crane controller to at least partially compensate for at least one component of the movement of the implement and/or the movement of the at least one part of the implement.

The further operating mode can be activated by the user for example before or during implementation of particular work processes with the implement, i.e. the crane controller can be switched into the further operating mode by the user.

The activation of the further operating mode can, however, also be effected automatically, for example when it is recognized that particular work processes are being carried out with the implement. The crane arm of the crane or the crane tip of the crane arm can in principle also be substantially freely movable in the second operating mode of the crane controller—within the possible, structurally limited range of movement and optionally taking into account the stability of the crane.

By predetermined control commands for movement of the implement arranged on the crane tip and/or for movement of the at least one part of the implement arranged on the crane tip can be meant possible working movements of the implement. The predetermined control commands in an exemplary embodiment of the implement as a grab with two or more grab jaws or grab shells that are movable in relation to each other can thus comprise control commands for the opening and/or closing movement of the grab jaws or grab shells. In the case of a further exemplary embodiment of the implement as a bucket (also called excavation bucket or scoop) the predetermined control commands can comprise control commands issued by the user for movement of the bucket in relation to the crane arm or the crane tip.

The crane controller is now configured so that, when such predetermined control commands named by way of example are issued by the user, additional control commands for movement of the at least one crane arm can be given off by the crane controller. In addition to the control commands issued by the user to the implement, control commands for movement of the crane arm or at least one part of the crane arm can thus be given off by the crane controller. These additional control commands for movement of the at least one crane arm serve to at least partially compensate for at least one component of the movement of the implement and/or the movement of the at least one part of the implement. Parts of the movement of the implement can thus be at least proportionately compensated for by a movement of the crane arm due to the additional control commands.

It can be advantageous that the additional control commands can be given off as a function of at least one parameter of the movement of the implement arranged on the crane tip and/or the movement of the at least one part of the implement arranged on the crane tip. Corresponding sensors can be provided to detect the parameter of the movement of the implement or the at least one movable part of the implement. The additional control commands can be given off in proportion to the at least one parameter of the movement of the implement arranged on the crane tip and/or the movement of the at least one part of the implement arranged on the crane tip.

In principle it can be advantageous that the additional control commands can be given off by the crane controller substantially simultaneously with the issue of the predetermined control commands for movement of the implement and/or of the at least one part of the implement. The at least proportionate balancing-out of a part of the movement of the implement can thus be effected simultaneously with the movement of the implement.

It can further be advantageous that the crane tip is displaceable in a plane of the crane arm during the movement of the crane arm due to the additional control commands of the crane controller. The position of the crane arm or the position of parts of the crane arm in relation to each other can be alterable due to the additional control commands.

It can further be advantageous that the crane tip is displaceable—preferably along a straight line—in a direction of the at least one component during the movement of the crane arm due to the additional control commands of the crane controller. The control of the crane arm due to the additional control commands can be effected such that the crane tip moves in a direction of the part of the movement to be balanced out, wherein this is preferably effected along a straight line. The direction of movement of the crane tip can run substantially counter to the direction of the part of the movement of the implement to be balanced out and/or of the part of the movement of the at least one movable part of the implement to be balanced out.

It can be provided that the movement of the implement and/or of the at least one part of the implement is a pivoting movement in relation to the crane tip.

The implement itself can perform a pivoting movement in relation to the crane tip and/or a movable part of the implement can perform a pivoting movement in relation to the crane tip.

It can be provided that the crane arm has at least one crane pillar—preferably rotatable about a perpendicular axis of rotation—and at least one lifting arm pivotally mounted on the crane pillar—preferably about a first horizontal pivot axis—wherein the lifting arm preferably has at least one extension arm.

It can be advantageous that the crane arm further has at least one articulated arm, a so-called jib, pivotally mounted on the lifting arm—preferably about a second horizontal pivot axis—wherein the articulated arm preferably has at least one extension arm.

It can further be advantageous that the crane arm further has at least one articulated attachment arm pivotally mounted on the articulated arm preferably about a third horizontal pivot axis, a so-called jib-in-jib configuration, wherein the articulated attachment arm preferably has at least one extension arm.

In principle it can be provided that the crane controller has at least one memory for storing data specific to the crane and/or data specific to implements arrangeable on the crane. The data specific to the crane can comprise information for designing the crane such as for example arm lengths, number and length of extension arms and the like. Specific data for implements arrangeable on the crane can comprise information for designing the implement such as for example number and length or size of grab jaws or grab shells in an exemplary embodiment of the implement as a grab. The crane controller can also comprise signal inputs for supplying sensor signals from sensors arrangeable on the crane and/or from sensors arrangeable on an implement arranged on the crane. A position or geometry detection of the crane or crane arm can be made possible by the sensors arrangeable on the crane. The position of the implement in relation to the crane tip or the position of the at least one movable part of the implement can be detectable by sensors arrangeable on the implement. The crane controller can further comprise signal outputs for outputting control signals for the at least one crane arm and/or for the implement and/or for the at least one part of the implement. The control signals output via the signal outputs can be output for example to control devices such as for instance control valves of the crane for the implementation of the movement. The crane controller can additionally have operating elements able to be operated by a user for the generation or issue of control commands for movement of the at least one crane arm and/or of the implement and/or of the at least one part of the implement. The crane controller can also have a computing unit for processing data from the memory and sensor signals and for generating control commands.

It can be advantageous that the crane controller is configured so that an implement arranged on the crane tip is able to be predefined to the crane controller by a user and/or an implement arranged on the crane tip is automatically recognizable by the crane controller. Information specific to an implement arranged on the crane tip can thus be predefined to the crane controller or this information can be automatically recognized by the crane controller. The output of the additional control commands can thus be effected as a function of the predefined and/or recognized implement on the basis of the information specific to the implement.

In the case of an implement arranged on the crane tip of the crane arm it can be advantageous that the implement is formed as a grab with at least two grab jaws, each pivotally movable about a bearing point on the implement, with grab tips, or with at least two grab shells, each pivotally movable about a bearing point on the implement, with grab blades. A pivoting movement (opening and/or closing movement) of the grab jaws or the grab shells can correspond to a movement of the implement. During such a movement of the implement the grab tips or the grab blades can move on a path that is curved substantially circularly at least in sections about the bearing points on the implement.

It can be advantageous that the grab tips or grab blades move substantially along a straight line or in a plane during an opening and/or closing movement of the grab jaws or grab shells through the movement of the crane arm due to the additional control commands. The movement of the crane arm resulting from the additional control commands can move the crane tip such that an at least partial compensation for at least one component of the opening and/or closing movement of the grab jaws or grab shells results. A component of the pivoting movement of the implement taking place during the opening and/or closing movement and/or of the pivoting movement of the at least one movable part of the implement can thus be compensated for, with the result that the grab tips or grab blades essentially no longer move on a circular path, but are effectively moved substantially in a straight line. During an opening and/or closing movement of the grab jaws or grab shells, the grab tips or grab blades can, for example, thus effectively move away from each other or towards each other substantially in a straight line. In the case of a grab suspended freely from the crane tip of a crane, a movement of the grab tips or grab shells running substantially horizontally and at a constant height (measured from the ground on which the crane is positioned or else measured from a bottom edge of the crane pillar) for example can thus be achieved.

It can be advantageous that the component of the movement at least partially compensated for is the normal distance, which changes during an opening and/or closing movement, from the straight line or plane to the respective bearing point. The normal distance relates to the distance from the straight line or plane, measured on the shortest route along or in which the grab tips or grab blades effectively move, to the respective bearing point. The normal distance from the straight line or plane can increase during a closing movement of the grab jaws or grab shells, and it can decrease during an opening movement. The crane arm can be moved due to the additional control commands such that the increase or decrease in the normal distance is compensated for by the movement of the crane tip.

It can further be advantageous that the predetermined control commands by a user for movement of the implement and/or for movement of the at least one part of the implement comprise control commands for opening and/or closing the grab jaws or grab shells of the grab. Thus, when control commands are issued by a user by means of the crane controller for the opening and/or closing of the grab jaws or grab shells of an implement designed as a grab with two or more grab jaws or grab shells that are movable in relation to each other, additional control commands can be given off by the crane controller to at least partially compensate for at least one component of the movements implemented during the opening and/or closing movement of the grab jaws or grab shells.

It can also be advantageous that the at least one parameter of the movement is the opening and/or closing angle of the grab jaws or grab shells. Corresponding sensors for detecting the opening and/or closing angle of the grab jaws or grab shells can be provided on the grab. The additional control commands can be given off in proportion to the detected opening and/or closing angle of the grab jaws or grab shells.

Further details and advantages of the present invention are explained in more detail below with the aid of the description of the figures with reference to the embodiment examples represented in the drawings. There are shown in:

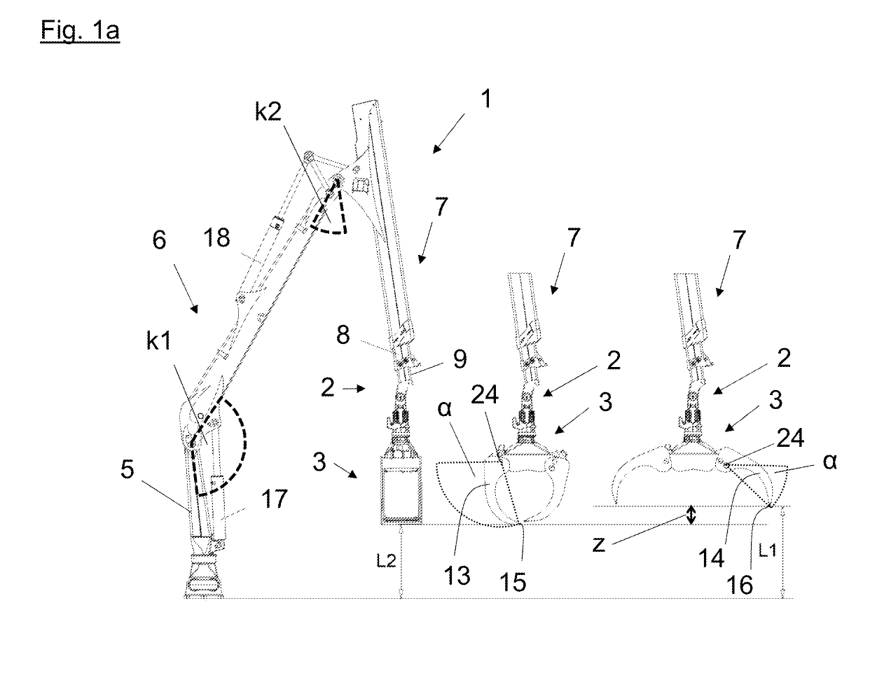

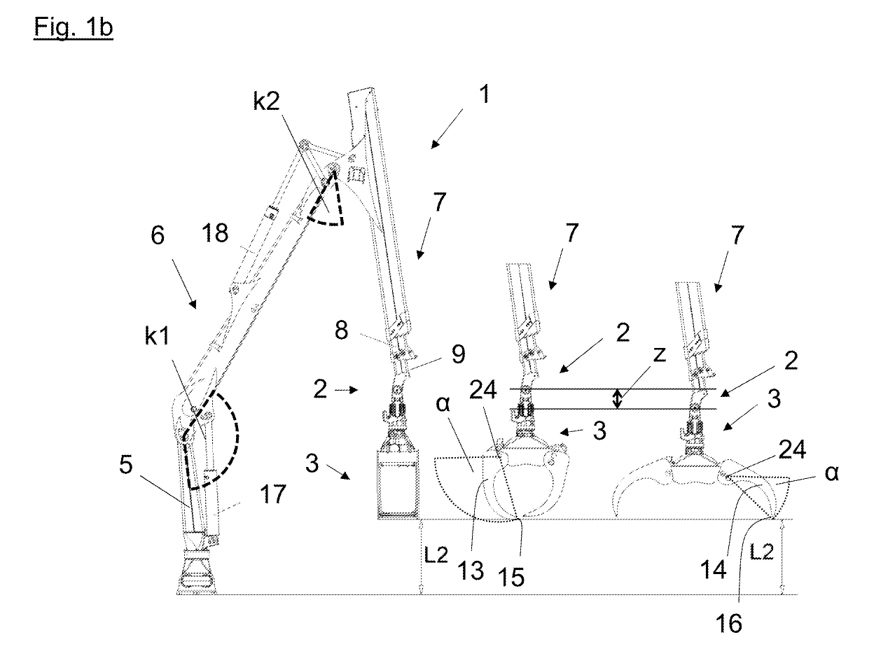

FIGS. 1a and 1b side and detail views of a first embodiment of a crane,

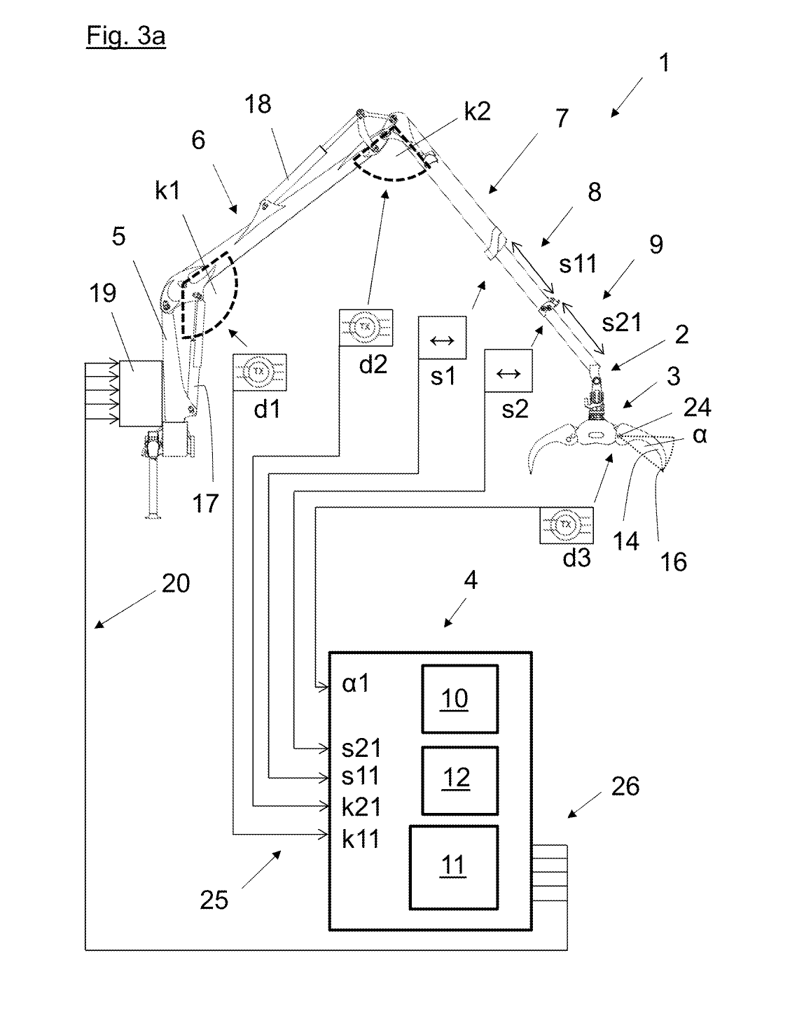

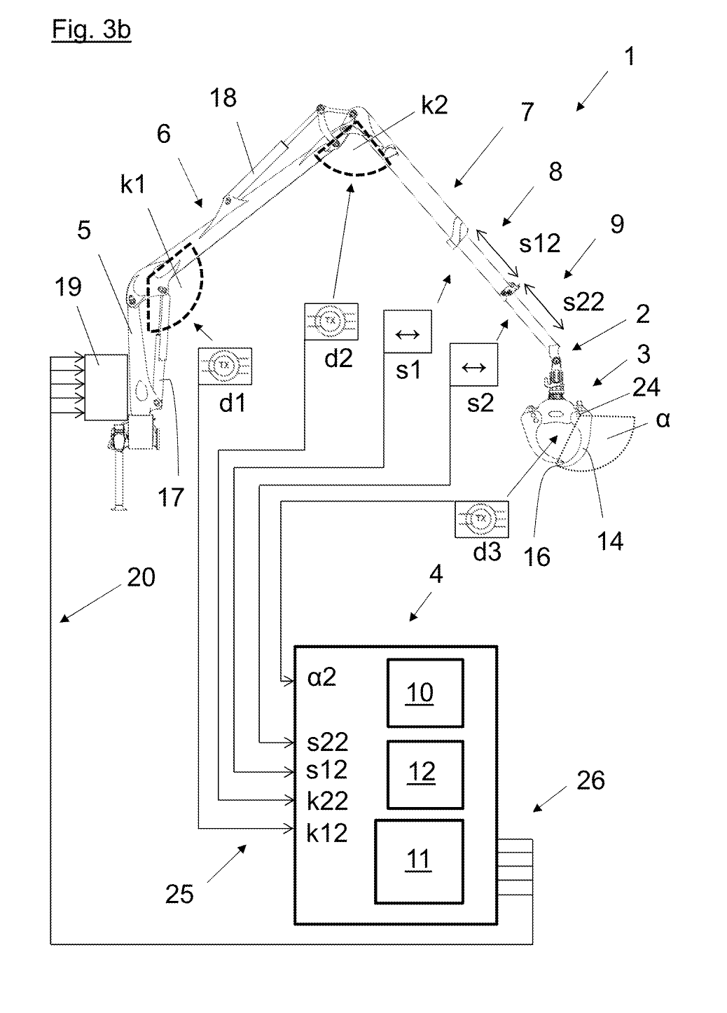

FIGS. 3a and 3b side views of the second embodiment of the crane and in each case a schematic representation of a crane controller with a sensor system,

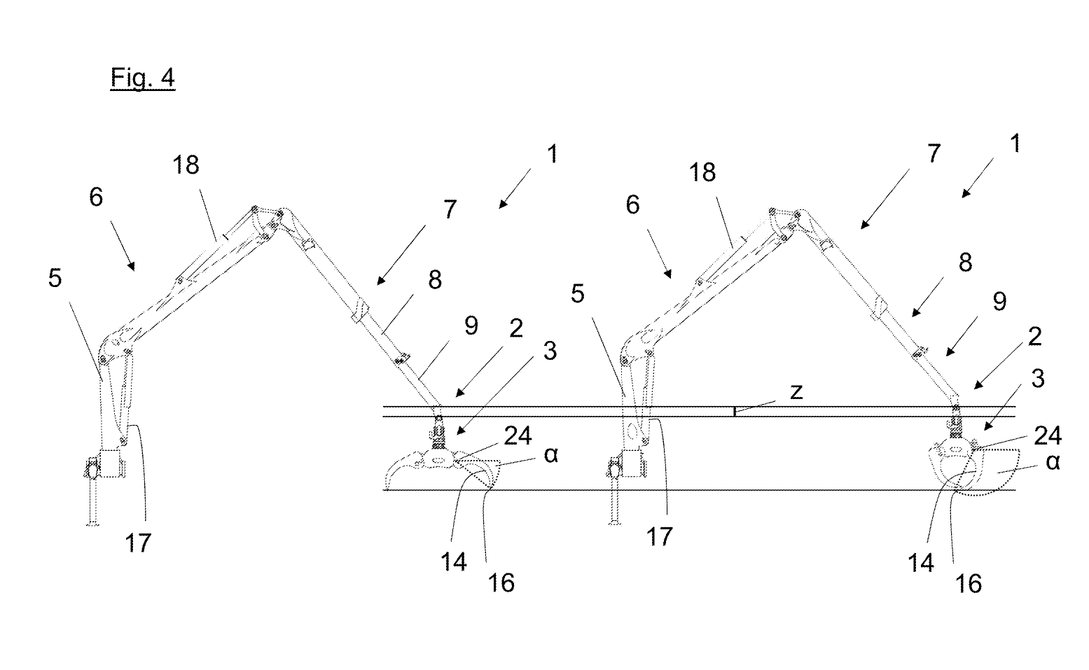

FIG. 4 side views of the second embodiment of the crane,

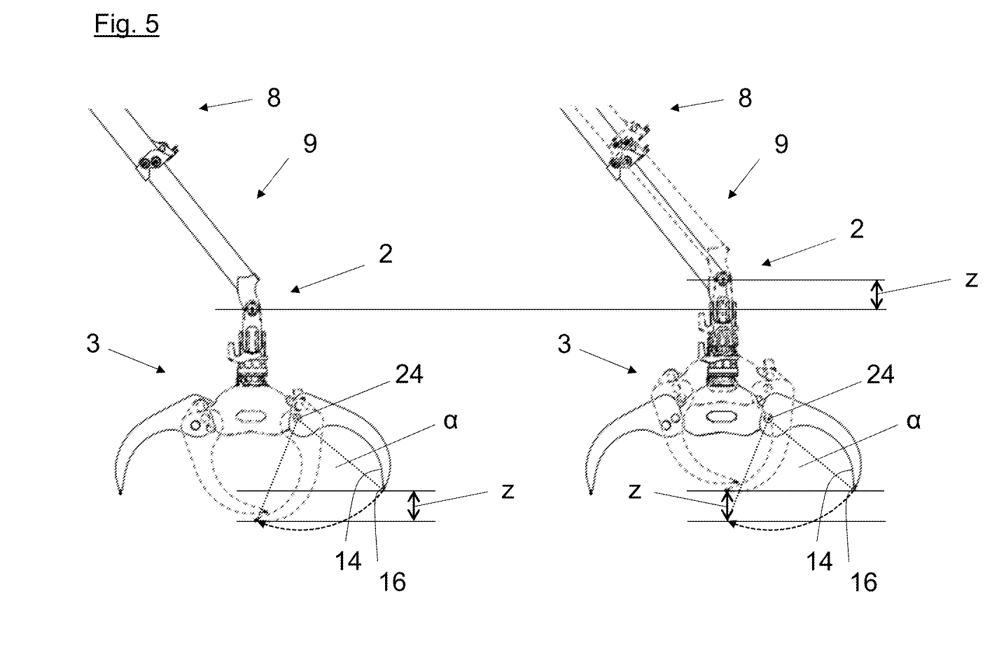

FIG. 5 detail view of the second embodiment of the crane,

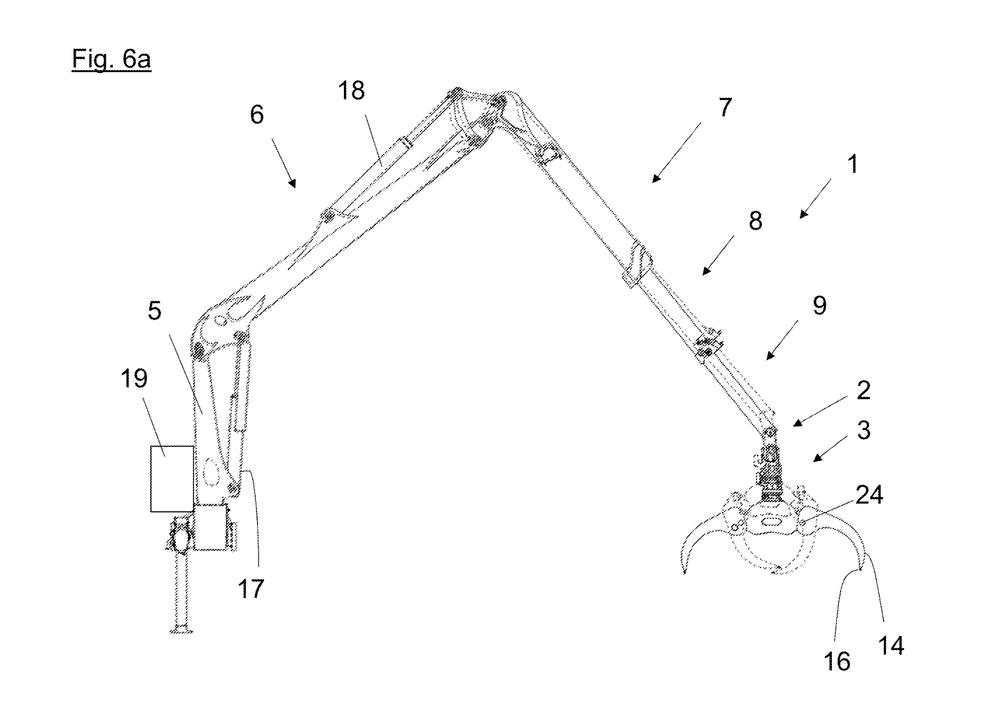

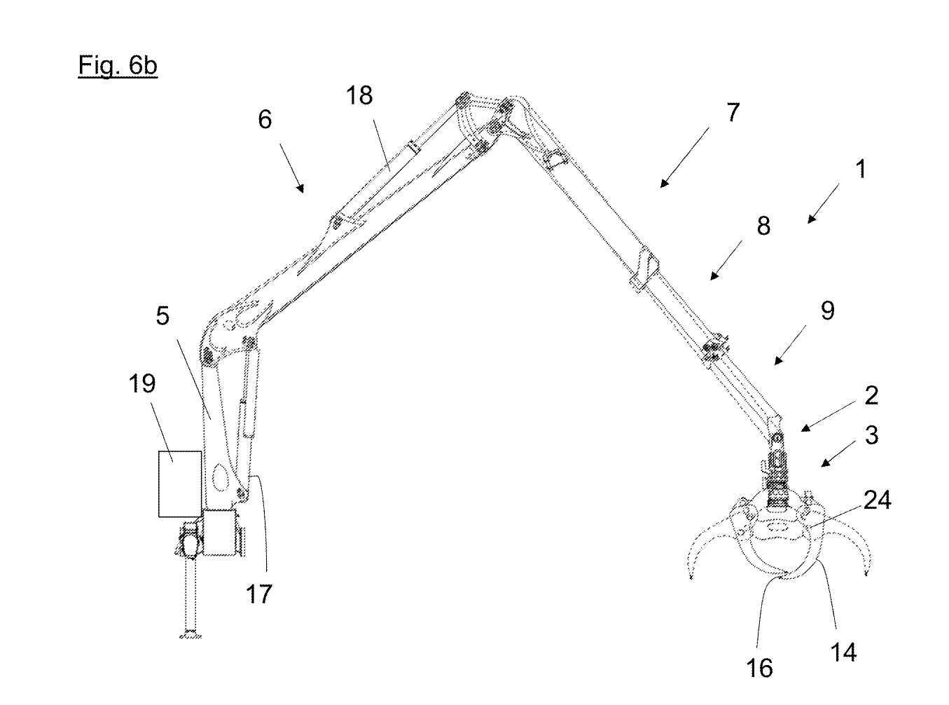

FIGS. 6a and 6b further side views of the second embodiment of the crane,

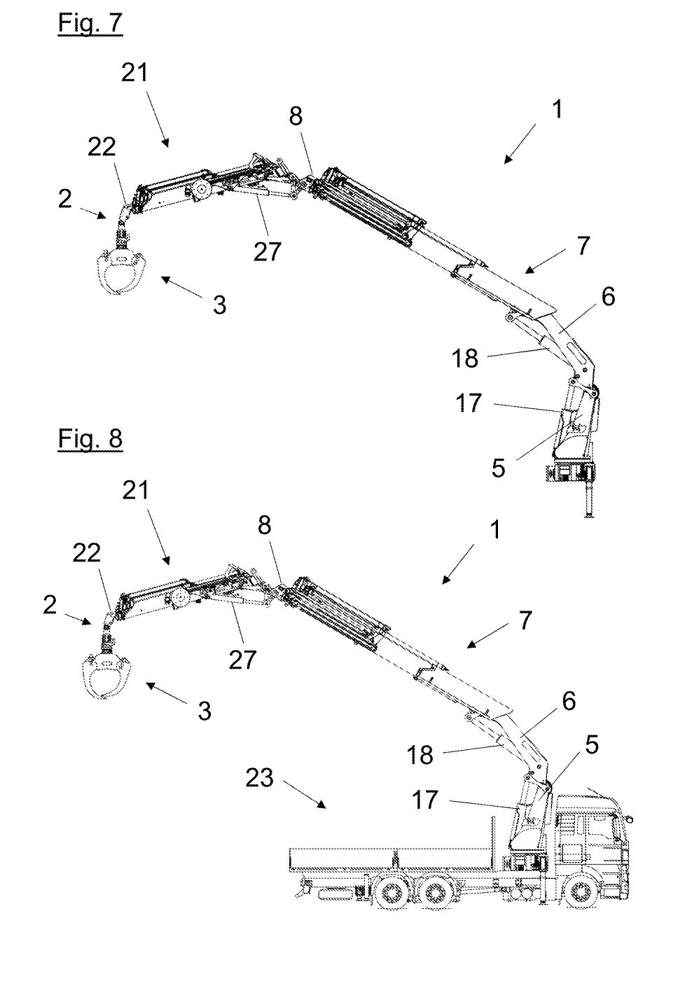

FIG. 7 a third embodiment of a crane, and

FIG. 8 a vehicle with a third embodiment of the crane.

FIG. 1 a shows a side view and detail views of a first embodiment of a crane 1 with a crane pillar 5 (optionally rotatable about a perpendicular axis of rotation), a lifting arm 6 pivotally mounted on the latter and an articulated arm 7 pivotally mounted thereon. In the position of the crane 1 shown the lifting arm 6 is arranged on the crane pillar 5 at a first articulation angle k1 and the articulated arm 7 is arranged on the lifting arm 6 at a second articulation angle k2. A main cylinder 17 or an articulation cylinder 18 is provided to pivot the lifting arm 6 or the articulated arm 7. In the embodiment 2 shown the articulated arm 7 has two extension arms 8, 9, by means of which the length of the articulated arm 7 can be altered. A freely suspended implement 3 in the form of a grab is arranged on the crane tip 2, which in the embodiment shown is formed by the free end of the articulated arm 7. The crane arm of the crane 1, as represented in this embodiment, comprises the crane pillar 5, the lifting arm 6 and the articulated arm 7 with its extension arms 8, 9.

In the adjacent detail views, in each case, a lower section of the articulated arm 7 with implement 3 arranged thereon in the form of a grab is shown, wherein the grab in the embodiment shown is rotated by 90° compared with the overall view of the crane 1 shown on the left, whereby two grab jaws 13, 14 with grab tips 15, 16 are visible. The grab jaws 13, 14 are pivotally mounted about bearing points 24. The opening angle of the grab or the grab jaws 13, 14 is given the reference a. In the first detail view the grab is shown in a closed position of the grab jaws 13, 14 and in the second detail view the grab is shown in an open position of the grab jaws 13, 14. Unless the crane arm of the crane 1 itself is moved, different heights (vertical distances) with respect, for example, to the lower edge of the crane pillar 5, the position of which is represented by the line running horizontally in the drawing, result for the grab tips 15, 16 due to the pivoting of the grab jaws 13, 14 during the opening and/or closing. For example, in the closed position of the grab a first distance L1 from the grab tips 15, 16 to the lower edge of the crane pillar 5 thus essentially results. In the open position of the grab a second distance L2 from the grab tips 15, 16 to the lower edge of the crane pillar 5 essentially results. The difference between the distances L1,

L2 is given the reference z, and corresponds, as represented, to the vertical component of the pivoting movement of the grab jaws 15, 16. The represented opening or closing position of the implement 3 designed as a grab results, for example, when the implement 3 is controlled in a first operating mode of the crane controller (not represented in FIG. 1a or 1b, for details on this see FIG. 3 for example).

FIG. 1b shows an opening or closing position of the implement 3 designed as a grab analogous to FIG. 1 a, wherein here the control of the implement 3 is effected in a second operating mode of the crane controller according to the invention. Due to a movement of the crane arm, here specifically a raising or lowering of the crane tip 2 by the vertical component, which changes during the closing or opening of the grab, of the position of the grab tips 15, 16 in relation to, for example, the lower edge of the crane pillar 5, the distance L2 or the effective height position of the grab tips 15, 16 can be kept constant. The same distance L2 to the lower edge of the crane pillar 5 thus results both in the closed position and in the open position of the grab. Through such a guiding of the grab tips 15, 16 running substantially horizontally as represented, for example damage to the crane 1, to the implement 3, to any load to be lifted or to a base which serves as supporting surface for the crane 1 or as depositing surface for any load to be lifted can be avoidable.

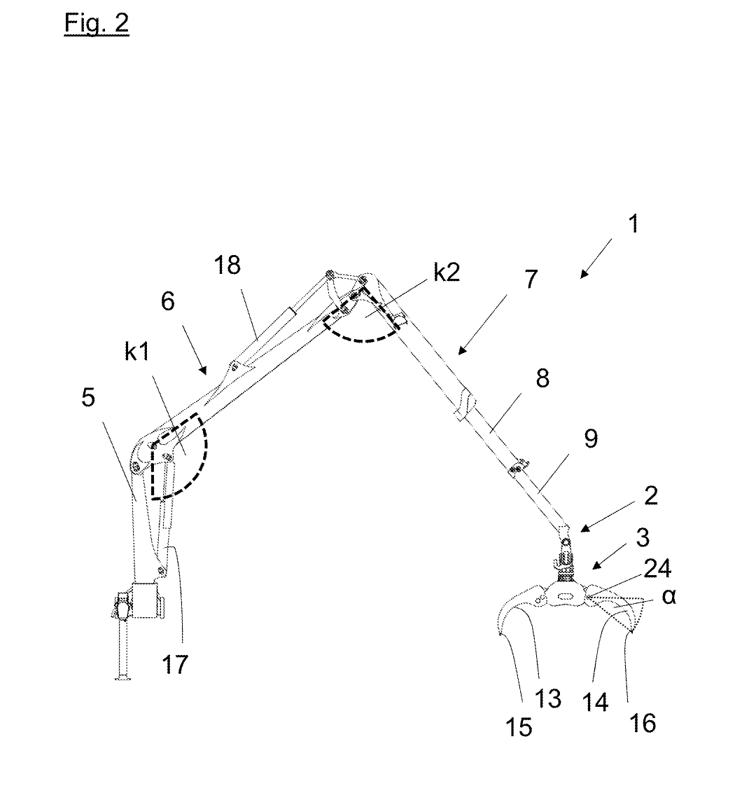

FIG. 2 shows a second embodiment of a crane 1, wherein structurally and functionally similar elements of the crane 1 have the same references as in the embodiment of FIG. 1a or 1b. The crane arm of the crane 1, as represented in this embodiment, again comprises the crane pillar 5, the lifting arm 6 and the articulated arm 7 with its extension arms 8, 9.

FIGS. 3a and 3b show side views of the second embodiment of the crane 1 and in each case a schematic representation of a crane controller 4 with a sensor system. The crane 1 has a first rotary encoder d1 for detecting the first articulation angle k1, a second rotary encoder d2 for detecting the second articulation angle k2, a first extension position sensor s1 for detecting the extension position of the first extension arm 8 and a second extension position sensor s2 for detecting the extension position of the second extension arm 9. Contrary to what is represented, however, the detection of the first articulation angle k1 and/or of the second articulation angle K 2 can also be effected by detection of the extension length of the main cylinder 17 or by detection of the extension length of the articulation cylinder 18. The implement 3 arranged on the crane and formed as a grab has a third rotary encoder d3 for detection of the opening angle α. The detection of the opening angle α can, however, also be effected by detection of the extension length of a hydraulic cylinder (not represented) for actuation of the grab jaws 13, 14. Through the sensor system fitted on the crane and on the implement 3, the crane position can be detected by detection of the crane geometry and the opening or closing position of the implement 3. In the embodiment shown the crane controller 4 has signal inputs 25 for supplying sensor signals via signal lines of the sensors and signal outputs 26 for outputting control commands via a control line 20. For conversion of the control commands into corresponding movements of the crane arm of the crane 1 as well as of the implement 3, it has a valve block 19, by which, for example by means of corresponding control commands, hydraulic valves for the hydraulic powering of hydraulic positioning devices (such as for example the main cylinder 17 and the articulation cylinder 18) can be controlled. The crane controller 4 further has a memory 10, a computing unit 12 and operating elements 11, by means of which control commands for the crane 1 or the implement 3 can be input by a user. The operating elements 11 can, for example, also be arranged or present on a mobile radio remote control. The computing unit 12 serves, for example, to generate control commands, optionally taking into account data stored in the memory 10.

In the position of the crane 1 or the implement 3 shown in FIG. 3a the first articulation angle k1 has the detected value k11, the second articulation angle k2 has the detected value k21, the extension position of the first extension arm 8 has the detected value s11, the extension position of the second extension arm 9 has the detected value s21 and the opening angle α of the implement 3 formed as a grab has the detected value α1. Contrary to what is represented, however, the detection of the extension position of the first extension arm 8 and the second extension arm 9—and thus the detection of the effective length of the articulated arm 7—can be effected by a common or individual extension position sensor, such as can be advantageous for example in a movement-coupled embodiment of the extension arms 8, 9 (for example by a chain, not represented). The corresponding sensor signals can be fed to the crane controller 4 via the signal inputs 25 and stored in the memory 10 and used for further calculations by the computing unit 12.

If, in the second operating mode of the crane controller 4, a control command is now issued by a user, for example by actuation of one of the operating elements 11, to close the implement 3 formed as a grab arranged on the crane tip 2, then additional control commands for movement of the crane arm are given off by the crane controller 4 automatically and without further intervention by the user, to at least partially compensate for the vertical component of the movement of the grab jaws 13, 14 or the grab tips 15, 16 of the implement 3 formed as a grab.

Due to the additional control commands the crane 1 is now in the position shown in FIG. 3b. In this position of the crane 1 or the implement 3 the first articulation angle k1 has the detected value k12, the second articulation angle k2 has the detected value k22, the extension position of the first extension arm 8 has the detected value s12, the extension position of the second extension arm 9 has the detected value s22 and the opening angle α of the implement 3 formed as a grab has the detected value α2. The change in the articulation angle positions as well as the extension positions can be effected continuously and simultaneously with the change in the opening angle α of the implement 3 formed as a grab.

The positions of the crane 1 or the implement 3 shown in FIGS. 3a and 3b are represented next to each other in FIG. 4. It is recognizable that effectively a raising of the crane tip 2, the vertical component z, has resulted from the additional control commands given off in the second operating mode of the crane controller 4 during the closing of the implement 3 formed as a grab with the resultant change in geometry of the crane arm. The grab tips 15, 16 of the grab jaws 14, 15 of the implement 3 formed as a grab have thereby effectively remained at the same height during the closing process, i.e. have been guided substantially horizontally.

FIG. 5 shows a comparison of a closing movement of an implement 3 designed as a grab without compensation for the vertical component z, as would be the case for example in the case of a control of the implement 3 in the first operating mode of the crane controller 4, and with compensation for the vertical component z, as would be the case for example in the case of a control of the implement 3 in the second operating mode of the crane controller 4. In each case an implement 3 formed as a grab freely suspended on a crane tip 2 of a crane arm represented in sections is represented, wherein the implement 3 in the open position is shown with continuous lines and the implement 3 in the closed position is shown with dotted or dashed lines. It is clearly recognizable that in the case of a control of the implement 3 in a first operating mode of the crane controller 4 the vertical position of the grab tips 15, 16 during the closing process changes by the vertical component z. In the case of a control of the implement 3 in the second operating mode of the crane controller 4 the change in the vertical component z can be compensated for by the output of additional control commands for movement of the crane arm. In the example shown this is effected by raising the crane tip 2 by the corresponding vertical component z, as represented.

FIGS. 6a and 6b show a superposition of the end positions of the crane 1 in the case of a closing or opening movement of an implement 3 designed as a grab and arranged on the crane tip 2 of the crane 1 in the case of a control of the implement 3 in the second operating mode of the crane controller 4. It is clearly recognizable that a movement, and thus a change in geometry, of the crane arm of the crane 1 is effected by the additionally output control commands to compensate for the vertical component z of the closing or opening movement of the grab.

FIGS. 7 and 8 show a third embodiment of a crane 1, as well as a vehicle 28 with such a crane 1. Structurally and functionally similar elements of the crane 1 are given the same references as in the previously discussed embodiments. The crane arm of the crane 1, as represented in this embodiment, comprises the crane pillar 5, the lifting arm 6, the articulated arm 7 with at least one extension arm 8 as well as an articulated attachment arm 21 with at least one extension arm 22. To change the articulation position of the articulated attachment arm 21 relative to the articulated arm 7, a further articulation cylinder 27 is provided.

### LIST OF REFERENCES

Crane 1
Crane tip 2
Implement 3
Crane controller 4
Crane pillar 5
Lifting arm 6
Articulated arm 7
Extension arm 8
Extension arm 9
Memory 10
Operating elements 11
Computing unit 12
Grab jaw 13
Grab jaw 14
Grab tip 15
Grab tip 16
Main cylinder 17
Articulation cylinder 18
Valve block 19
Control line 20
Articulated attachment arm 21
Extension arm 22
Vehicle 23
Bearing point 24
Signal inputs 25
Signal outputs 26
Articulation cylinder 27
Articulation angle k1
Articulation angle k2
Opening angle α
Distance L1
Distance L2
Difference z
Rotary encoder d1
Rotary encoder d2
Extension position sensor s1
Extension position sensor s2
Rotary encoder d3
Articulation angle k11, k12, k21, k22
Opening angle α1, α2

1. Crane with
at least one crane arm with a crane tip, wherein an implement is arrangeable on the crane tip, wherein the implement and/or at least one part of the implement is movable in relation to the crane tip, and
a crane controller for controlling the at least one crane arm and the implement and/or the at least one part of the implement, wherein the crane controller in a first operating mode is configured to issue control commands by a user for movement of the at least one crane arm and for movement of the implement and/or for movement of the at least one part of the implement, wherein
the crane controller has an activatable further operating mode, in which the crane controller is configured so that, with an implement arranged on the crane tip, when predetermined control commands are issued by a user for movement of the implement arranged on the crane tip and/or for movement of the at least one part of the implement arranged on the crane tip, additional control commands for movement of the at least one crane arm can be given off by the crane controller to at least partially compensate for at least one component of the movement of the implement and/or the movement of the at least one part of the implement.

2. The crane according to claim 1, wherein the additional control commands can be given off as a function of at least one parameter of the movement of the implement arranged on the crane tip and/or the movement of the at least one part of the implement arranged on the crane tip.

3. The crane according to claim 1, wherein the additional control commands can be given off by the crane controller substantially simultaneously with the issue of the predetermined control commands for movement of the implement and/or of the at least one part of the implement.

4. The crane according to claim 1, wherein the crane tip is displaceable in a plane of the crane arm during the movement of the crane arm due to the additional control commands of the crane controller.

5. The crane according to claim 1, wherein the crane tip is displaceable in a direction of the at least one component—preferably along a straight line—during the movement of the crane arm due to the additional control commands of the crane controller.

6. The crane according to claim 1, wherein the movement of the implement and/or of the at least one part of the implement is a pivoting movement in relation to the crane tip.

7. The crane according to claim 1, wherein the crane arm has at least one crane pillar preferably rotatable about a perpendicular axis of rotation—and at least one lifting arm pivotally mounted on the crane pillar preferably about a first horizontal pivot axis—wherein the lifting arm preferably has at least one extension arm.

8. The crane according to claim 1, wherein the crane arm further has at least one articulated arm pivotally mounted on the lifting arm—preferably about a second horizontal pivot axis—wherein the articulated arm preferably has at least one extension arm.

9. The crane according to claim 1, wherein the crane arm further has at least one articulated attachment arm pivotally mounted on the articulated arm preferably about a third horizontal pivot axis—wherein the articulated attachment arm preferably has at least one extension arm.

10. The crane according to claim 1, wherein the crane controller has at least the following:
a memory for storing data specific to the crane and/or data specific to implements arrangeable on the crane
signal inputs for supplying sensor signals from sensors arrangeable on the crane and/or from sensors arrangeable on an implement arranged on the crane
signal outputs for outputting control signals for the at least one crane arm and/or for the implement and/or for the at least one part of the implement
operating elements for the issue of control commands for movement of the at least one crane arm and/or of the implement and/or of the at least one part of the implement
a computing unit for processing data from the memory and sensor signals and for generating control commands.

11. The crane according to claim 1, wherein the crane controller is configured so that an implement arranged on the crane tip is able to be predefined to the crane controller by a user and/or an implement arranged on the crane tip is automatically recognizable by the crane controller, and additional control commands specific to the implement can be given off as a function of the predefined and/or recognized implement.

12. The crane according to claim 1 with an implement arranged on the crane tip of the crane arm.

13. The crane according to claim 1, wherein the implement is formed as a grab with
at least two grab jaws, each pivotally movable about a bearing point on the implement, with grab tips or with
at least two grab shells, each pivotally movable about a bearing point on the implement, with grab blades.

14. The crane according to claim 1, wherein the grab tips or grab blades move substantially along a straight line or in a plane during an opening and/or closing movement of the grab jaws or grab shells through the movement of the crane arm due to the additional control commands.

15. The crane according to claim 1, wherein the component of the movement at least partially compensated for is the normal distance, which changes during an opening and/or closing movement, from the straight line or plane to the respective bearing point.

16. The crane according to claim 1, wherein the predetermined control commands by a user for movement of the implement and/or for movement of the at least one part of the implement comprise control commands for opening and/or closing the grab jaws or grab shells of the grab.

17. The crane according to claim 2, wherein the at least one parameter of the movement is the opening and/or closing angle of the grab jaws or grab shells.
